(19) United States
(12) Patent Application Publication
(10) Pub. No.: US 2016/0216573 A1
(43) Pub. Date: Jul. 28, 2016

(54) LIQUID CRYSTAL DISPLAY

(71) Applicant: Samsung Display Co., Ltd, Yongin-si (KR)

(72) Inventors: Ka Eun KIM, Yongin-si (KR); Cheol SHIN, Hwaseong-si (KR); Hak Sun CHANG, Yongin-si (KR); Ki Chul SHIN, Seongnam-si (KR); Se Hyun LEE, Seoul (KR)

(21) Appl. No.: 14/966,803

(22) Filed: Dec. 11, 2015

(30) Foreign Application Priority Data
Jan. 26, 2015 (KR) 10-2015-0012374

(51) Int. Cl. G02F 1/1343

(52) U.S. Cl. CPC G02F 1/134309

(57) ABSTRACT

An exemplary embodiment of the present system and method provides a liquid crystal display including: a first substrate; a first electrode formed on the first substrate; a second substrate configured to face the first substrate; and a second electrode formed on the second substrate, wherein the first electrode includes a first portion having a plate shape and a plurality of branch electrodes extended from the first portion, the second electrode includes a cross-shaped cutout including a horizontal stem and a vertical stem that cross each other at a center thereof, and the vertical stem of the cross-shaped cutout includes a first portion having a width that is increased from an end of the first portion of the vertical stem toward the center.

### CROSS-REFERENCE TO RELATED APPLICATION

This application claims priority to and the benefit of Korean Patent Application No. 10-2015-0012374 filed in the Korean Intellectual Property Office on Jan. 26, 2015, the entire contents of which are incorporated herein by reference.

### BACKGROUND

(a) Technical Field

The present disclosure relates to a liquid crystal display.

(b) Description of the Related Art

A liquid crystal display is one of the most common types of flat panel displays currently in use and generally includes two sheets of display panels with field generating electrodes, such as a pixel electrode, a common electrode, and the like, and a liquid crystal layer interposed therebetween. The liquid crystal display operates by applying voltages to the field generating electrodes to generate an electric field in the liquid crystal layer. By controlling the strength of the electric field, the liquid crystal display controls the alignment of liquid crystal molecules in the liquid crystal layer and thereby controls the polarization of incident light to display images.

In a vertically aligned (VA) mode liquid crystal display, the long axis of the liquid crystal molecules is arranged to be perpendicular to upper and lower display panels when an electric fields is not applied. A VA mode liquid crystal display generally provides a high contrast ratio and is easy to implement a wide standard viewing angle.

To implement a wide viewing angle in a vertically aligned mode liquid crystal display, a plurality of domains in which the liquid crystal molecules have different alignment directions may be formed in one pixel. As a means of forming the plurality of domains as such, there is a method of forming cutouts, such as slits and the like, in the field generating electrodes. Using the method, the liquid crystal molecules are rearranged by a fringe field generated between edges of the cutouts and the field generating electrodes facing the edges thereof, thereby forming the plurality of domains.

In the case of a liquid crystal display including a plurality of domains, a portion of a pixel electrode may be formed to have a plate shape without slits or the like to increase transmittance. However, the influence of a fringe field is reduced at a plate-shaped portion of the pixel electrode. As a result, the liquid crystal molecules are irregularly moved, and the display quality is deteriorated.

The above information disclosed in this Background section is only for enhancement of understanding of the background of the present disclosure and therefore may contain information that does not form the prior art that is already known in this country to a person of ordinary skill in the art.

### SUMMARY

The present system and method include a liquid crystal display including a plurality of domains and having advantages of preventing irregular movement of liquid crystal molecules while increasing transmittance of the liquid crystal display.

An exemplary embodiment of the present system and method provides a liquid crystal display including: a first substrate; a first electrode formed on the first substrate; a second substrate configured to face the first substrate; and a second electrode formed on the second substrate, wherein the first electrode includes a first portion having a plate shape and a plurality of branch electrodes extended from the first portion, the second electrode includes a cross-shaped cutout including a horizontal stem and a vertical stem that cross each other at a center thereof, and the vertical stem of the cross-shaped cutout includes a first portion having a width that is increased from an end of the first portion of the vertical stem toward the center.

The vertical stem of the cross-shaped cutout may further include a second portion having a constant width, and the first portion of the vertical stem may be positioned between the second portion and the center.

A length of the first portion of the vertical stem may be about 50% or more of a length of the vertical stem.

The vertical stem may have a width that is gradually increased from an end thereof toward the center.

The first portion of the first electrode may have a rhombus shape, and the branch electrodes may be disposed to extend in four directions.

The cross-shaped cutout of the second electrode may include an extension formed at the center, and an edge of the extension may be parallel with an edge of the first portion of the first electrode.

According to an exemplary embodiment of the present system and method, a liquid crystal display includes a plurality of domains that are capable of preventing irregular movement of liquid crystal molecules while increasing transmittance of the liquid crystal display.

### BRIEF DESCRIPTION OF THE DRAWINGS

FIG. 1 is a layout view of a liquid crystal display according to an exemplary embodiment of the present system and method;

FIG. 2 is a cross-sectional view of the liquid crystal display taken along the line II-II shown in FIG. 1;

FIG. 3 is a plan view illustrating a basic region of a field generating electrode of the liquid crystal display according to an exemplary embodiment of the present system and method;

FIG. 4 is a circuit diagram of a liquid crystal display according to an exemplary embodiment of the present system and method;

FIG. 5 is a layout view of a liquid crystal display according to an exemplary embodiment of the present system and method;

FIG. 6 is a plan view illustrating a basic region of a field generating electrode of the liquid crystal display according to an exemplary embodiment of the present system and method;

FIG. 7 and FIG. 8 illustrate results of experimental examples of the present system and method;

FIG. 9 illustrates two subpixels included in one pixel of a liquid crystal display according to an exemplary embodiment of the present system and method;

FIG. 10 is an equivalent circuit diagram of one pixel of a liquid crystal display according to an exemplary embodiment of the present system and method;

FIG. 11 is an equivalent circuit diagram of one pixel of a liquid crystal display according to an exemplary embodiment of the present system and method; and

FIGS. 12, 13 and 14 are equivalent circuit diagrams of one pixel of a liquid crystal display according to exemplary embodiments of the present system and method.

### DETAILED DESCRIPTION OF THE EMBODIMENTS

The present system and method are described more fully hereinafter with reference to the accompanying drawings in which exemplary embodiments of the present system and method are shown. As those skilled in the art would realize, the described embodiments may be modified in various different ways, all without departing from the spirit or scope of the present system and method.

In the drawings, the thickness of layers, films, panels, regions, etc., is exaggerated for clarity. Like reference numerals designate like elements throughout the specification. When an element, such as a layer, film, region, or substrate, is referred to as being “on” another element, it may be directly on the other element, or intervening elements may also be present. In contrast, when an element is referred to as being “directly on” another element, there are no intervening elements present.

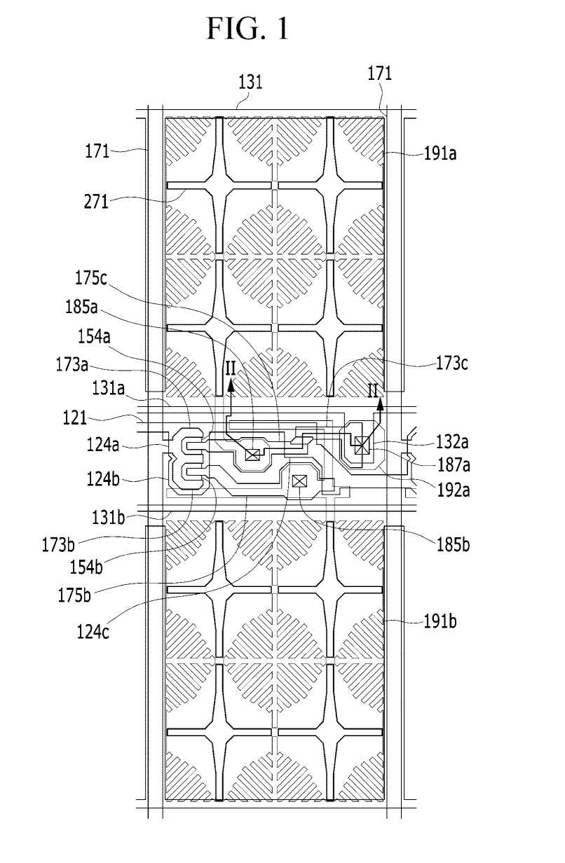

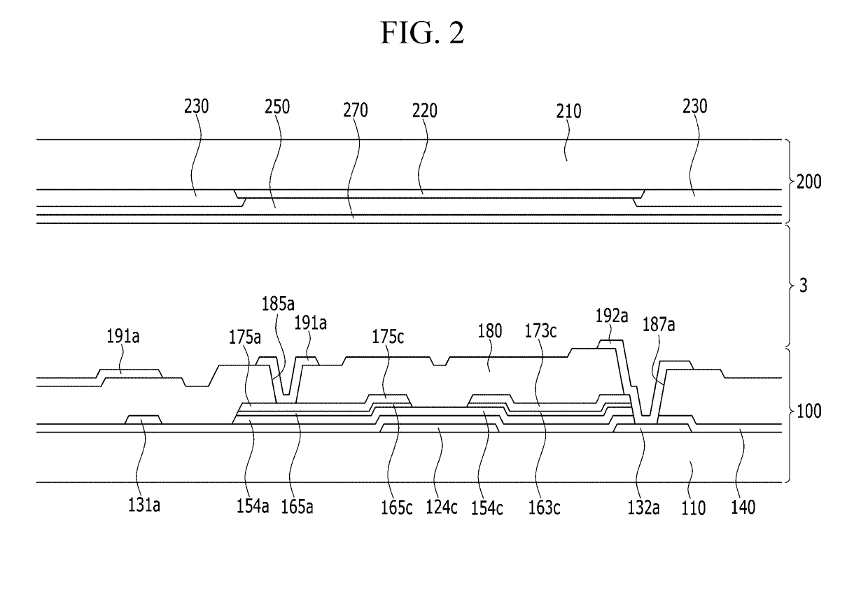

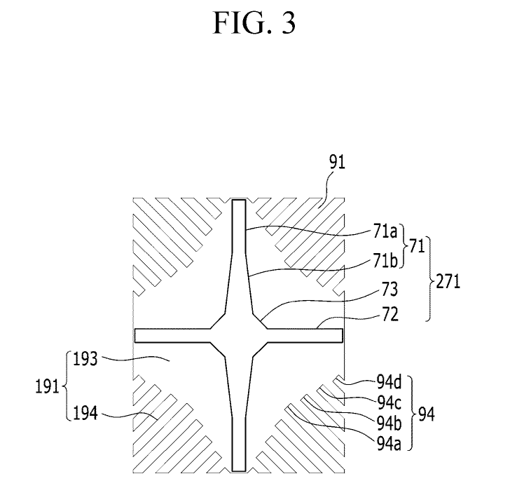

A liquid crystal display according to an exemplary embodiment of the present system and method is described with reference to FIG. 1 to FIG. 3. FIG. 1 is a layout view of a liquid crystal display according to an exemplary embodiment of the present system and method. FIG. 2 is a cross-sectional view of the liquid crystal display taken along the line II-II shown in FIG. 1. FIG. 3 is a top plan view illustrating a basic region of a field generating electrode of the liquid crystal display according to an exemplary embodiment of the present system and method.

First, referring to FIG. 1 and FIG. 2, the liquid crystal display according to an exemplary embodiment includes a lower display panel 100 and an upper display panel 200 disposed to face each other, and a liquid crystal layer 3 interposed between the two display panels 100 and 200.

Hereinafter, the lower display panel 100 is described.

Gate conductors including a gate line 121, a storage electrode line 131, a first voltage transfer line 131a, and a second voltage transfer line 131b are formed on a first substrate 110.

The gate line 121 serves to transmit a gate signal, and includes a first gate electrode 124a, a second gate electrode 124b, and a third gate electrode 124c.

A gate insulating layer 140 is disposed on the gate conductors 121, 131, 131a, and 131b.

A first semiconductor 154a, a second semiconductor 154b, and a third semiconductor 154c are disposed on the gate insulating layer 140.

Ohmic contacts 165a, 163c, and 165c are disposed on the first semiconductor 154a, the second semiconductor 154b, and the third semiconductor 154c. If the semiconductors 154a, 154b, and 154c include an oxide semiconductor, the ohmic contacts may be omitted.

Data conductors including data lines 171 including a first source electrode 173a, and a second source electrode 173b, a third source electrode 173c, a first drain electrode 175a, a second drain electrode 175b, and a third drain electrode 175c are formed on the ohmic contacts 165a, 163c, and 165c and the gate insulating layer 140. The first drain electrode 175a and the third drain electrode 175c are connected to each other.

A passivation layer 180 is formed on the data conductors 171, 173a, 173b, 173c, 175a, 175b, and 175c. The passivation layer 180 may be made of an inorganic insulator or an organic insulator.

A first contact hole 185a for partially exposing the first drain electrode 175a and a second contact hole 185b for partially exposing the second drain electrode 175b are formed in the passivation layer 180.

A third contact hole 187a is formed in the gate insulating layer 140 and the passivation layer 180 to expose a portion 132a of the first voltage transfer line 131a and a portion of the third source electrode 173c.

A first subpixel electrode 191a, a second subpixel electrode 191b, and a first connecting member 192a are formed on the passivation layer 180.

The first subpixel electrode 191a is physically and electrically connected to the first drain electrode 175a through the first contact hole 185a, and the second subpixel electrode 191b is physically and electrically connected to the second drain electrode 175b through the second contact hole 185b.

The first subpixel electrode 191a and the second subpixel electrode 191b are separated from each other with the gate line 121 therebetween, and are disposed at the upper and lower sides of the pixel area based on the gate line 121 to be adjacent to each other in a column direction (see FIG. 1). The first subpixel electrode 191a and the second subpixel electrode 191b each include a plate-shaped portion 193 having a substantially rhombus shape, and a plurality of branch electrodes 194 extending in four different directions from the plate-shaped portion 193 (see FIG. 3).

For example, the branch electrodes 194 shown in FIG. 3 include ones obliquely extended in the upper right direction, ones obliquely extended in the lower right direction, ones obliquely extended in the upper left direction, and ones obliquely extended in the lower left direction. As such, the liquid crystal molecules in the liquid crystal layer 3 corresponding to (e.g., overlapping) the branch electrodes 194 extended in different directions are inclined in the different directions. Accordingly, four domains in which the liquid crystal molecules are inclined in different directions are formed in the liquid crystal layer 3. When the liquid crystal molecules are inclined in various directions, a standard viewing angle of the LCD becomes wider.

Each of the first subpixel electrode 191a and the second subpixel electrode 191b is divided into a plurality of subregions by the branch electrodes 194 extending in four different directions.

The first connecting member 192a is formed on the third contact hole 187a to connect the first voltage transfer line 131a to the third source electrode 173c.

The first gate electrode 124a, the first semiconductor 154a, the first source electrode 173a, and the first drain electrode 175a constitute a first switching element Qa. The second gate electrode 124b, the second semiconductor 154b, the second source electrode 173b, and the second drain electrode 175b constitute a second switching element Qb. The third gate electrode 124c, the third semiconductor 154c, the third source electrode 173c, and the third drain electrode 175c constitute a third switching element Qc.

The second display panel 200 is now described.

A light blocking member 220 is disposed on a second substrate 210. The light blocking member 220 is also called a black matrix and serves to prevent light leakage. A plurality of color filters 230 are disposed on the second substrate 210 and the light blocking member 220. An overcoat 250 is disposed on the color filters 230. The overcoat 250 prevents the color filters 230 from being lifted and suppresses contamination of the liquid crystal layer 3 by an organic material, such as a solvent, flowing from the color filters 230, thereby preventing an abnormality, such as a residual image, from occurring when the screen is driven. In some cases, the overcoat 250 may be omitted. A common electrode 270 is disposed on the overcoat 250.

In the liquid crystal display according to the above-described exemplary embodiment, the light blocking member 220 and the color filters 230 are disposed in the upper display panel 200. However, the light blocking member 220 and the color filters 230 may be disposed in the lower display panel 100 in a liquid crystal display according to another exemplary embodiment of the present system and method. In such case, the color filters 230 may be disposed instead on the passivation layer 180 of the first display panel 100.

The common electrode 270 has a cross-shaped cutout 271 that is formed to correspond to each basic region of the first subpixel electrode 191a and the second subpixel electrode 191b, such as shown in FIG. 3. The cutout 271 of the common electrode 270 may have a cross shape in a plan view.

When the liquid crystal display is viewed from above, such as shown in FIG. 2, each subregion of the first subpixel electrode 191a and the second subpixel electrode 191b is divided into four areas by the cross-shaped cutout 271 of the common electrode 270 and the branch electrodes 194 of the pixel electrodes 191a and 191b.

The pixel electrode 191a and 191b and the common electrode 270 include a plurality of basic regions, which is described later with reference to FIG. 3, constituting a plurality of subregions.

The liquid crystal layer 3 disposed between the two display panels 100 and 200 has a plurality of liquid crystal molecules having negative dielectric anisotropy. Negative dielectric anisotropy generally means that the liquid crystal molecules are arranged such that their long axes are perpendicular to the planar surfaces of the two display panels 100 and 200 when no electric field is generated in the liquid crystal layer 3.

The first subpixel electrode 191a, the common electrode 270, and the liquid crystal layer 3 disposed therebetween constitute the first liquid crystal capacitor Clca. The second subpixel electrode 191b, the common electrode 270, and the liquid crystal layer 3 disposed therebetween constitute the second liquid crystal capacitor Clcb.

When voltages are applied to the first subpixel electrode 191a and the second subpixel electrode 191b and a common voltage is applied to the common electrode, an electric field is generated in the liquid crystal layer 3, and the orientation of the liquid crystal molecules in the liquid crystal layer 3 is determined by the electric field intensity. The luminance of the light passing through the liquid crystal layer 3 varies according to the orientation of the liquid crystal molecules.

Next, a basic region of a field generating electrode of the liquid crystal display according to an exemplary embodiment of the present system and method is described in more detail with reference to FIG. 3. FIG. 3 is a plan view illustrating a basic region of a field generating electrode of the liquid crystal display according to an exemplary embodiment of the present system and method.

As shown in FIG. 3, the basic region of the field generating electrode of the liquid crystal display according to an exemplary embodiment has an overall quadrangular shape.

The basic region includes the rhombus plate-shaped portion 193, the pixel electrode 191 including the branch electrodes 194 extending in four different directions from the plate-shaped portion 193, and a cutout 271 of the common electrode disposed to face the branch electrodes 194.

A central portion of the plate-shaped portion 193 of the pixel electrode 191 is overlapped with a central portion of the cross-shaped cutout 271 formed in the common electrode 270.

The branch electrodes 194 of the pixel electrode 191 include ones obliquely extended in the upper right direction, ones obliquely extended in the lower right direction, ones obliquely extended in the upper right direction, and ones obliquely extended in the lower left direction.

The cutout 271 of the common electrode 270 includes a vertical stem 71 and a horizontal stem 72. The cutout 271 of the common electrode 270 further includes an extension 73 extended from a portion at which the vertical stem 71 and the horizontal stem 72 meet each other.

The vertical stem 71 of the cutout 271 of the common electrode 270 includes a first vertical portion 71a having a constant width and a second vertical portion 71b having a width that is gradually increased from the first vertical portion 71a toward the horizontal stem 72.

A ratio of a length of the second vertical portion 71b to an entire length of the vertical stem 71 of the cutout 271 of the common electrode 270 may be about 50% or more.

The branch electrodes 194 of the pixel electrode 191 are defined by a plurality of cutouts 91.

Ends 94 of the cutouts 91 by which the branch electrodes 94 of the pixel electrode 191 are defined are parallel with a corresponding edge of the extension 73 of the cutout 271 of the common electrode.

Ends 94 of the cutouts 91 by which the branch electrodes 194 of the pixel electrode 191 are defined are not positioned in the same line. Specifically, a first end 94a of the cutout 91 formed to correspond to each of four edges of the basic regions of the field generating electrodes is extended toward the central portion of the basic region of the corresponding field generating electrode and, among the ends 94, is closest to the central portion of the basic region. A second end 94b, a third end 94c, and a fourth end 94d are sequentially formed from the first end 94a to an edge of the basic region of the field generating electrode to be gradually more distant from the central portion of the basic region.

Accordingly, the cutout 91 formed to correspond to each of four edges of the basic regions of the field generating electrodes may be formed to extend to the central portion of each domain. As a result, an azimuthal angle, which is a direction in which the director of the liquid crystal molecules is inclined, that is, the direction of the director of the liquid crystal molecules, may be more easily controlled.

Further, the vertical stem 71 of the cutout 271 of the common electrode 270 includes the first vertical portion 71a having a constant width and the second vertical portion 71b having a width that is gradually increased from the first vertical portion 71a toward the horizontal stem 72. The intensity of a fringe field generated by the cutout 271 is proportional to a width of the cutout 271. Accordingly, the intensity of the fringe field generated by the second vertical portion 71b at a portion at which the second vertical portion 71b is formed is increased toward the extension 73.

As such, by varying the width of the second vertical portion 71b vertically formed at the central portion of each basic region of the field generating electrodes, the azimuthal angle, which is a direction in which the director of the liquid crystal molecules positioned to be adjacent to the second vertical portion 71b (i.e., the direction of the director of the liquid crystal molecules) can be additionally controlled, thereby preventing irregular movement of the liquid crystal molecules positioned to be adjacent to the second vertical portion 71b that is overlapped with the plate-shaped portion 193 of the pixel electrode 191.

Herein, the azimuthal angle indicates an angle in which the director of the liquid crystal molecules projected onto a substrate surface is inclined with respect to a signal line, e.g., the gate line or the data line.

In accordance with the liquid crystal display according to an exemplary embodiment of the present system and method, transmittance of the liquid crystal display may be improved by forming the plate-shaped portion 193 of the pixel electrodes of the basic regions of the field generating electrodes. Further, the vertical stem 71 of the cutout 271 of the common electrode 270 formed at each basic region of the field generating electrode may be formed to include the first vertical portion 71a having a constant width and the second vertical portion 71b having a width that is gradually increased from the first vertical portion 71a toward the horizontal stem 72. As a result, the azimuthal angle, which is a direction in which the director of the liquid crystal molecules positioned to be adjacent to the second vertical portion 71b (i.e., the direction of the director of the liquid crystal molecules) can be additionally controlled, thereby preventing irregular movement of the liquid crystal molecules positioned to be adjacent to the second vertical portion 71b that is overlapped with the plate-shaped portion 193 of the pixel electrode 191.

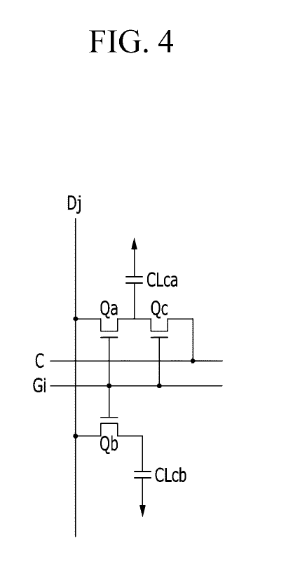

Hereinafter, a driving method of a liquid crystal display according to an exemplary embodiment of the present system and method is described with reference to FIG. 4

FIG. 4 is a circuit diagram of a liquid crystal display according to an exemplary embodiment of the present system and method.

Referring to FIG. 4, the liquid crystal display includes a plurality of signal lines Gi, Dj, and C, a first switching element Qa, a second switching element Qb, and a third switching element Qc connected thereto, and a first liquid crystal capacitor Clca and a second liquid crystal capacitor Clcb.

The signal lines Gi, Dj, and C include a gate line Gi for transferring a gate signal (also referred to as a “scanning signal”), a data line Dj for transferring a data voltage, and a reference voltage line C for transferring a predetermined reference voltage.

A reference voltage having a constant magnitude is applied to the reference voltage line C, and a polarity or magnitude of the reference voltage is varied per frame. For example, when the common voltage has a magnitude of 7.5 V, the reference voltage has a magnitude of about 15 V or about 0 V per frame. The reference voltage may be greater or smaller than the maximum value of the data voltage. Further, the difference between the reference voltage and the common voltage when the reference voltage has positive polarity with respect to the common voltage may be different from the difference between the reference voltage and the common voltage when the reference voltage has negative polarity with respect to the common voltage.

The first switching element Qa and the second switching element Qb are respectively connected to the gate line Gi and the first data line Dj, and the third switching element Qc is connected to the gate line Gi, the reference voltage line C, and an output terminal of the first switching element Qa.

The first switching element Qa and the second switching element Qb are three-terminal elements, such as thin film transistors, and have a control terminal connected to the gate line Gi and an input terminal connected to the first data line Dj. Further, an output terminal of the first switching element Qa is connected to the first liquid crystal capacitor Clca and an output terminal of the third switching element Qc, and an output terminal of the second switching element Qb is connected to the second liquid crystal capacitor Clcb.

The third switching element Qc is also a three-terminal element, such as a thin film transistor, and includes a control terminal connected to the gate line Gi, an input terminal connected to the reference voltage line C, and an output terminal connected to the first liquid crystal capacitor Clca and the output terminal of the first switching element Qa.

When a gate-on signal is applied to the gate line Gi, the first switching element Qa, second switching element Qb, and third switching element Qc connected to the gate line Gj are turned on, and the data voltage applied to the first data line Dj is respectively applied to the first liquid crystal capacitor Clca and the second liquid crystal capacitor Clcb through the first switching element Qa and the second switching element Qb, respectively.

Continuing from the case above, because one terminal of the first liquid crystal capacitor Clca is connected to the output terminal of the third switching element Qc, and thus may be boosted by the reference voltage that is applied to the reference voltage line C through the third switching element Qc, the voltage charged in the first liquid crystal capacitor Clca is different from the voltage charged in the second liquid crystal capacitor Clcb. In this case, the reference voltage applied to the reference voltage line C may have the same polarity as that of the data voltage applied to the data line Dj, and may have a magnitude that is greater than that of the data voltage applied to the data line Dj. Accordingly, the reference voltage of the reference voltage line C applied through the third switching element Qc is divided, and thus the voltage charged in the first liquid crystal capacitor Clca has a level that is higher than if the first liquid crystal capacitor Clca is charged by only the data voltage applied through the data line Dj.

As a result, the voltage charged in the first liquid crystal capacitor Clca is different from the voltage charged in the second liquid crystal capacitor Clcb. Because the voltage charged in the first liquid crystal capacitor Clca is different from the voltage charged in the second liquid crystal capacitor Clcb, the angle in which the liquid crystal molecules are inclined in the first subpixel is different from the angle in which the liquid crystal molecules are inclined in the second subpixel, thereby allowing the luminance of two subpixels to be different from each other. Accordingly, by appropriately adjusting the voltage of the first liquid crystal capacitor Clca and the voltage of the second liquid crystal capacitor Clcb, the view of an image from the side may be controlled to approximate the view of the image from the front, thereby improving side visibility.

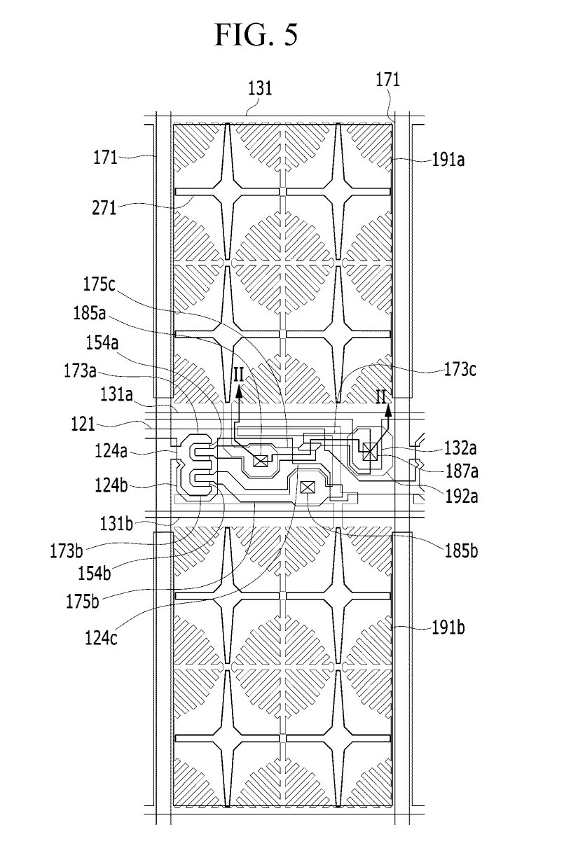

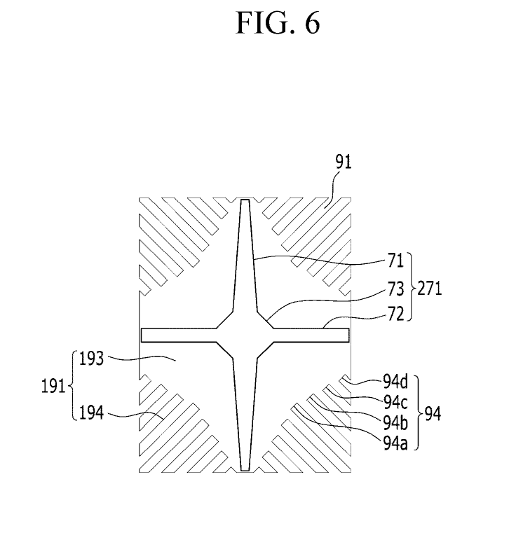

Hereinafter, a liquid crystal display according to an exemplary embodiment of the present system and method is described with reference to FIG. 5 and FIG. 6. FIG. 5 is a layout view of a liquid crystal display according to an exemplary embodiment of the present system and method. FIG. 6 is a plan view illustrating a basic region of a field generating electrode of the liquid crystal display according to an exemplary embodiment of the present system and method.

Referring to FIG. 5, the liquid crystal display is similar to the liquid crystal display according to the exemplary embodiment described with reference to FIG. 1 to FIG. 3. Detailed description of the same constituent elements is omitted.

The liquid crystal display according to the exemplary embodiment of FIG. 5 differs from the liquid crystal display according to the exemplary embodiment described with reference to FIG. 1 to FIG. 3 in that the vertical portion 71 (see FIG. 6) of the cutout 271 of the common electrode is formed such that the width thereof is increased from an end of the vertical portion 71 to the central portion of the cutout 271.

The liquid crystal display according to the present exemplary embodiment of FIG. 5 includes at least one basic region of the field generating electrode described with reference to FIG. 6.

Hereinafter, the basic region of the field generating electrode of the liquid crystal display according to the exemplary embodiment of FIG. 5 is described with reference to FIG. 6.

Referring to FIG. 6, the basic region of the field generating electrode of the liquid crystal display according to an exemplary embodiment has a quadrangular shape.

The basic region includes the rhomboid plate-shaped portion 193, the pixel electrode 191 including the branch electrodes 194 extending in four different directions from the plate-shaped portion 193, and the cutout 271 of the common electrode disposed to face the branch electrodes 194.

A central portion of the plate-shaped portion 193 of the pixel electrode 191 is overlapped with a central portion of the cross-shaped cutout 271 formed in the common electrode 270.

The branch electrodes 194 of the pixel electrode 191 include ones obliquely extended in the upper right direction, ones obliquely extended in the lower right direction, ones obliquely extended in the upper right direction, and ones obliquely extended in the lower left direction.

The cutout 271 of the common electrode 270 includes a vertical stem 71 and a horizontal stem 72. The cutout 271 of the common electrode 270 further includes an extension 73 extended from a portion at which the vertical stem 71 and the horizontal stem 72 meet each other.

A width of the vertical stem 71 of the cutout 271 of the common electrode 270 is gradually increased from an end thereof toward the extension 73.

According to the exemplary embodiment that was described above with reference to FIG. 3, the vertical stem 71 includes the first vertical portion 71a having the constant width and the second vertical portion 71b having the width that is gradually increased. In contrast, the width of the vertical stem 71 of the cutout 271 of the common electrode 270 of the liquid crystal display according to the exemplary embodiment of FIG. 5 is gradually increased from the end thereof toward the extension 73.

The branch electrodes 94 of the pixel electrode 191 are defined by a plurality of cutouts 91.

Ends 94 of the cutouts 91 by which the branch electrodes 94 of the pixel electrode 191 are defined are parallel with a corresponding edge of the extension 73 of the cutout 271 of the common electrode.

The ends 94 of the cutouts 91 by which the branch electrodes 94 of the pixel electrode 191 are defined are not positioned in the same line. Specifically, a first end 94a of the cutout 91 formed to correspond to each of four edges of the basic regions of the field generating electrodes is extended toward the central portion of the basic region of the corresponding field generating electrode and, among the ends 94, is closest to the central portion of the basic region. A second end 94b, a third end 94c, and a fourth end 94d are sequentially formed from the first end 94a to an edge of the basic region of the field generating electrode to be gradually more distant from the central portion of the basic region.

Accordingly, the cutout 91 formed to correspond to each of four edges of the basic regions of the field generating electrodes may be formed to extend to the central portion of each domain. As a result, an azimuthal angle, which is a direction in which the director of the liquid crystal molecules is inclined, that is, the direction of the director of the liquid crystal molecules, may be more easily controlled.

Further, the width of the vertical stem 71 of the cutout 271 of the common electrode 270 is gradually increased from the end thereof toward the central portion of each basic region of the field generating electrode. The intensity of a fringe field generated by the cutout 271 is proportional to a width of the cutout 271. Accordingly, the intensity of the fringe field generated by the vertical stem 71 is increased from an end thereof toward the central portion of the basic region of the field generating electrode.

As such, by varying the width of the basic region of the field generating electrode, the azimuthal angle, which is a direction in which the director of the liquid crystal molecules positioned to be adjacent to the vertical stem 71 (i.e., the direction of the director of the liquid crystal molecules) can be additionally controlled, thereby preventing irregular movement of the liquid crystal molecules positioned to be adjacent to the vertical stem 71 that is overlapped with the plate-shaped portion 193 of the pixel electrode 191.

In accordance with the liquid crystal display according to an exemplary embodiment of the present system and method, transmittance of the liquid crystal display may be improved by forming the plate-shaped portion 193 of the pixel electrodes of the basic regions of the field generating electrodes. Further, by forming the width of the vertical stem 71 of the cutout 271 of the common electrode 270 formed in the basic region of the field generating electrode to be increased from the end of the vertical stem 71 toward the central portion of the generating electrode, the azimuthal angle, which is a direction in which the director of the liquid crystal molecules positioned to be adjacent to the vertical stem 71 that is overlapped with the plate-shaped portion 193 of the pixel electrode 191 (i.e., the direction of the director of the liquid crystal molecules) can be additionally controlled, thereby preventing irregular movement of the liquid crystal molecules overlapped with the plate-shaped portion 193 of the pixel electrode 191.

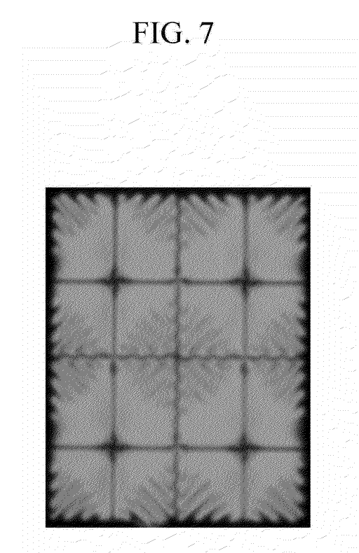

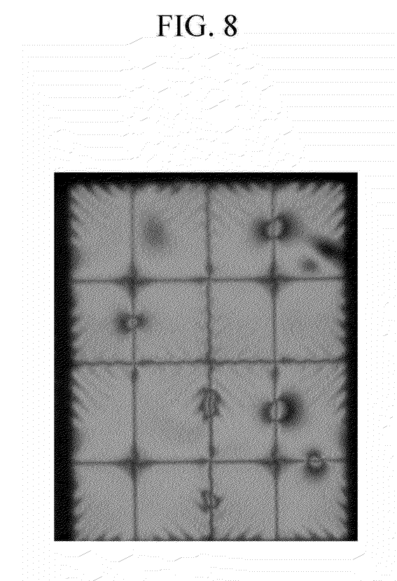

Hereinafter, experimental examples of the present system and method are described with reference to FIG. 7 and FIG. 8. That is, FIG. 7 and FIG. 8 illustrate results of experimental examples of the present system and method.

In the experimental examples, transmittance results were measured after the same voltage was applied to the field generating electrodes in a first case and a second case. In the first case, the width of the vertical stem 71 of the cutout 271 of the common electrode 270 of the liquid crystal display is varied according to an exemplary embodiment of the present system and method. In the second case, the vertical stem of the cutout of the common electrode is formed to have a constant width as in the conventional liquid crystal display. These results are illustrated in FIG. 7 and FIG. 8, respectively. That is, FIG. 7 illustrates the result of the first case, and FIG. 8 illustrates the result of the second case.

Referring to FIG. 7, it is seen that no transmittance deterioration is generated in the entire area in the first case in which the width of the vertical stem 71 of the cutout 271 of the common electrode 270 of the liquid crystal display is varied according to an exemplary embodiment of the present system and method. In contrast, referring to FIG. 8 showing the conventional liquid crystal display, irregular movement of the liquid crystal molecules is generated around the vertical stem 71 of the cutout 271 of the common electrode 270, thereby deteriorating the transmittance in the second case in which the vertical stem 71 of the cutout 271 of the common electrode 270 is formed to have a constant width.

As such, in accordance with the liquid crystal display according to an exemplary embodiment of the present system and method transmittance of the liquid crystal display may be improved by forming the plate-shaped portion 193 of the pixel electrodes of the basic regions of the field generating electrodes. Further, by forming the width of the vertical stem 71 of the cutout 271 of the common electrode 270 formed in the basic region of the field generating electrode to be increased from the end of the vertical stem 71 toward the central portion of the generating electrode, the azimuthal angle, which is a direction in which the director of the liquid crystal molecules positioned to be adjacent to the vertical stem 71 (i.e., the direction of the director of the liquid crystal molecules) can be additionally controlled, thereby preventing irregular movement of the liquid crystal molecules positioned to be adjacent to the vertical stem 71.

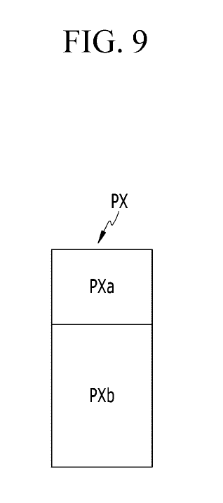

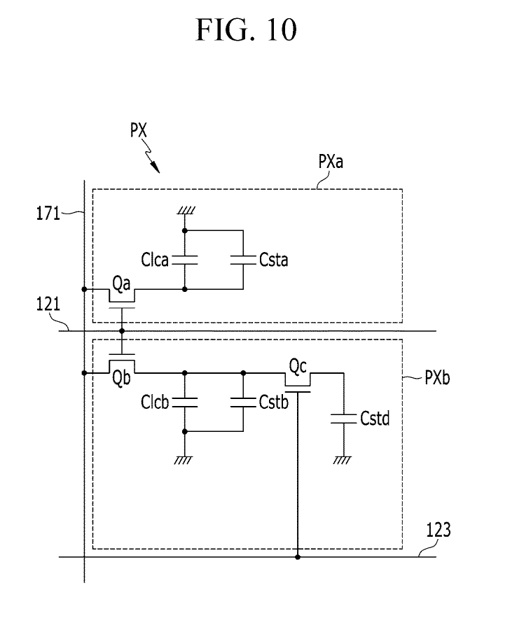

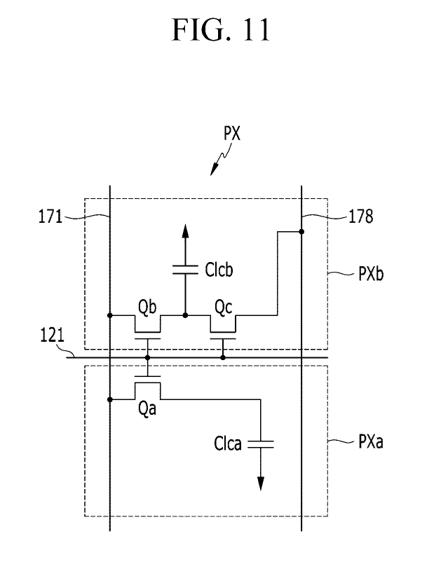

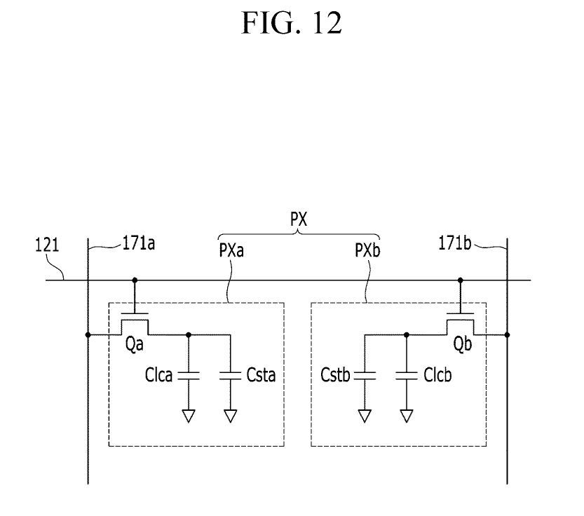

Hereinafter, liquid crystal displays according to other exemplary embodiments of the present system and method are described with reference to FIG. 9 to FIG. 14. FIG. 9 illustrates two subpixels included in one pixel of a liquid crystal display according to an exemplary embodiment of the present system and method. FIG. 10 is an equivalent circuit diagram of one pixel of a liquid crystal display according to an exemplary embodiment of the present system and method. FIG. 11 is an equivalent circuit diagram of one pixel of a liquid crystal display according to an exemplary embodiment of the present system and method. FIG. 12 to FIG. 14 are equivalent circuit diagrams of one pixel of a liquid crystal display according to exemplary embodiments of the present system and method.

Referring to FIG. 9, one pixel PX of a liquid crystal display according to an exemplary embodiment of the present system and method may include a first subpixel PXa and a second subpixel PXb. The first subpixel PXa and the second subpixel PXb may display images according to different gamma curves, and display images according to the same gamma curve for one input image signal. In other words, the first subpixel PXa and the second subpixel PXb of one pixel PX may display images having different luminance to improve side visibility for one input image signal. Areas of the first subpixel PXa and the second subpixel PXb may be the same as or different from each other.

As such, the pixel PX including the first subpixel PXa and the second subpixel PXb may have various circuit structures and dispositions to display the images having different luminance.

FIG. 10 is an equivalent circuit diagram of one pixel of a liquid crystal display according to an exemplary embodiment of the present system and method.

Referring to FIG. 10, the liquid crystal display includes signal lines including a gate line 121, a step-down gate line 123, and a data line 171, and a pixel PX connected to the signal lines.

Each pixel includes first and second subpixels PXa and PXb. The first subpixel PXa includes a first switching element Qa, a first liquid crystal capacitor Clca, and a first storage capacitor Csta, and the second subpixel PXb includes second and third switching elements Qb and Qc, a second liquid crystal capacitor Clcb, a second storage capacitor Cstb, and a step-down capacitor Cstd.

The first and second switching elements Qa and Qb are each connected to the gate line 121 and the data line 171, and the third switching element Qc is connected to the step-down gate line 123.

The switching elements Qa and Qb are three-terminal elements, such as thin film transistors, and control terminals thereof are connected to the gate lines 121, input terminals thereof are connected to the data lines 171, and output terminals thereof are respectively connected to the first and second liquid crystal capacitors Clca and Clcb and the first and second storage capacitors Csta and Cstb.

The third switching element Qc is also a three-terminal element, such as a thin film transistor, and a control terminal thereof is connected to the step-down gate line 123, an input terminal thereof is connected to the second liquid crystal capacitor Clcb, and an output terminal thereof is connected to the step-down capacitor Cstd.

The step-down capacitor Cstd is connected to the output terminal of the third switching element Qc and a common voltage.

An operation of the pixel PX is now described. When a gate-on voltage Von is firstly applied to the gate line 121, the first and second switching elements Qa and Qb connected thereto are turned on. Accordingly, the data voltage of the data line 171 is applied to the first and second liquid crystal capacitors Clca and Clcb through the turned-on first and second switching elements Qa and Qb, and thus the first and second liquid crystal capacitors Clca and Clcb are charged with a voltage corresponding to a difference between the data voltage Vd and the common voltage Vcom. In this case, a gate-off voltage Voff is applied to the step-down gate line 123.

Next, when the gate-off voltage Voff is applied to the gate line 121 and the gate-on voltage Von is applied to the step-down gate line 123, the first and second switching elements Qa and Qb are turned off, and the third switching element Qc is turned on. Accordingly, a charging voltage of the second liquid crystal capacitor Clcb connected to the output terminal of the second thin film transistor Qb is reduced. As a result, when the liquid crystal display is driven by frame inversion, the charging voltage of the second liquid crystal capacitor Clcb may always be lower than a charging voltage of the first liquid crystal capacitor Clca. Accordingly, it is possible to improve side visibility of the liquid crystal display by differentiating the charge voltages of the first and second liquid crystal capacitors Clca and Clcb.

FIG. 11 is an equivalent circuit diagram of one pixel of a liquid crystal display according to an exemplary embodiment of the present system and method.

Referring to FIG. 11, the liquid crystal display includes signal lines including the gate line 121, the data line 171, a reference voltage line 178 transferring a reference voltage, and the like, and the pixel PX connected thereto.

Each pixel includes first and second subpixels PXa and PXb. The first subpixel PXa includes the first switching element Qa and the first liquid crystal capacitor Clca, and the second subpixel PXb includes the second and third switching elements Qb and Qc and the second liquid crystal capacitor Clcb.

The first and second switching elements Qa and Qb are each connected to the gate line 121 and the data line 171, and the third switching element Qc is connected to the output terminal of the second switching element Qb and the reference voltage line 178.

The output terminal of the first switching element Qa is connected to the first liquid crystal capacitor Clca, and the output terminal of the second switching element Qb is connected to the second input liquid crystal capacitor Clcb and the input terminal of the third switching element Qc. The control terminal of the third switching element Qc is connected to the gate line 121, the input terminal thereof is connected to the second liquid crystal capacitor Clcb, and the output terminal thereof is connected to the reference voltage line 178.

An operation of the pixel PX shown in FIG. 11 is now described. When a gate-on voltage Von is applied to the gate line 121, the first, second, and third switching elements Qa, Qb, and Qc connected thereto are turned on. Accordingly, the data voltage applied to the data line 171 is applied to the first liquid crystal capacitor Clca and the second liquid crystal capacitor Clcb, respectively, through the first switching element Qa and the second switching element Qb, which are turned on, and thus the first liquid crystal capacitor Clca and the second liquid crystal capacitor Clcb are charged by the voltage difference between the data voltage and the common voltage Vcom. In this case, however, although the same data voltage is transferred to the first liquid crystal capacitor Clca and the second liquid crystal capacitor Clcb through the first and second switching elements Qa and Qb, the charging voltage of the second liquid crystal capacitor Clcb is divided through the third switching element Qc. As a result, the charging voltage of the second liquid crystal capacitor Clcb is smaller than that of the first liquid crystal capacitor Clca, and thus the luminance of the two subpixels PXa and Pxb may be different. Accordingly, by appropriately adjusting the voltage of the first liquid crystal capacitor Clca and the voltage of the second liquid crystal capacitor Clcb, the view of an image from the side can be controlled to approximate the view of the image from the front, thereby improving side visibility.

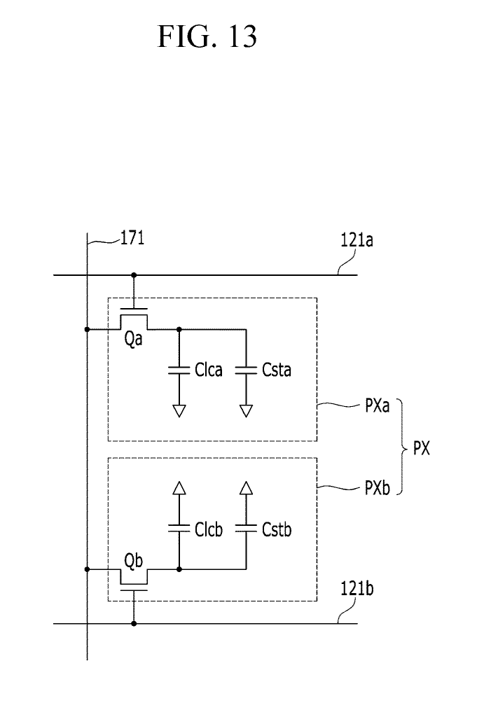

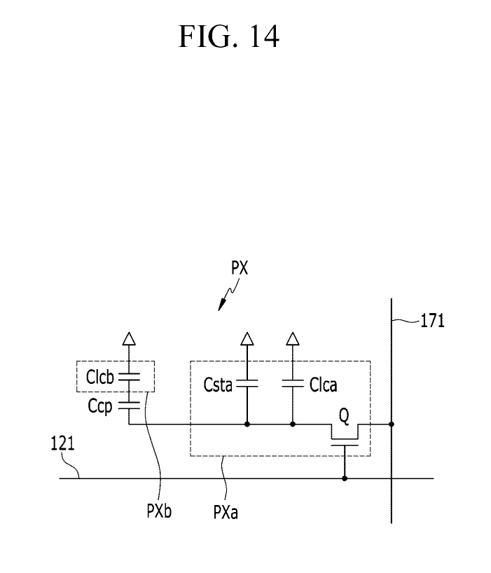

FIG. 12, FIG. 13, and FIG. 14 are respectively equivalent circuit diagrams of one pixel of a liquid crystal display according to exemplary embodiments of the present system and method, and illustrate various circuit structures of one pixel PX including the first subpixel PXa and the second subpixel PXb.

Referring to FIG. 12, the liquid crystal display according to an exemplary embodiment of the present system and method includes signal lines including first and second data lines 171a and 171b, and the gate line 121 and the pixel PX connected thereto.

Each pixel includes first and second subpixels PXa and PXb. The first subpixel PXa includes a first switching element Qa, a first liquid crystal capacitor Clca, and a first storage capacitor Csta, and the second subpixel PXb includes a second switching element Qb, a second liquid crystal capacitor Clcb, and a second storage capacitor Cstb.

The first switching element Qa includes a control terminal connected to the gate line 121 and an input terminal connected to the first data line 171a. An output terminal of the first switching element Qa is connected to the first liquid crystal capacitor Clca and the first storage capacitor Csta.

The second switching element Qb includes a control terminal connected to the gate line 121 and an input terminal connected to the second data line 171b. An output terminal of the second switching element Qb is connected to the second liquid crystal capacitor Clcb and the second storage capacitor Cstb.

The first liquid crystal capacitor Clca and second liquid crystal capacitor Clcb may receive different data voltages Vd for one input image signal IDAT through the first and second switching elements Qa and Qb, which are connected to different data lines 171a and 171b, respectively.

Next referring to FIG. 13, the display device according to an exemplary embodiment includes signal lines including a data line 171 and first and second gate lines 121a and 121b, and the pixel PX connected thereto. Each pixel includes first and second subpixels PXa and PXb.

The first switching element Qa included in the first subpixel PXa includes a control terminal connected to the first gate line 121a and an input terminal connected to the data line 171. An output terminal of the first switching element Qa is connected to the first liquid crystal capacitor Clca and the first storage capacitor Csta.

The second switching element Qb includes a control terminal connected to the second gate line 121b and an input terminal connected to the data line 171. An output terminal of the second switching element Qb is connected to the second liquid crystal capacitor Clcb and the second storage capacitor Cstb.

The first liquid crystal capacitor Clca and second liquid crystal capacitor Clcb may receive different data voltages Vd for one input image signal IDAT through the first and second switching elements Qa and Qb which are connected to different gate lines 121a and 121b, respectively.

Next referring to FIG. 14, the display device according to an exemplary embodiment includes signal lines including a data line 171 and a gate line 121, and the pixel PX connected thereto. Each pixel PX may include first and second subpixels Pxa and PXb, and a coupling capacitor Ccp connected between the two subpixels PXa and PXb.

The first subpixel Pxa includes a switching element Q connected to the gate line 121 and the data line 171, and a first liquid crystal capacitor Clca and a first storage capacitor Csta connected to the switching element Q. The second subpixel PXb includes a second liquid crystal capacitor Clcb connected to the coupling capacitor Ccp.

A control terminal of the switching element Q is connected to the gate line 121, an input terminal is connected to the data line 171, and an output terminal is connected to the first liquid crystal capacitor Clca, the first storage capacitor Csta, and the coupling capacitor Ccp. The switching element Q may transfer a data voltage Vd of the data line 171 to the first liquid crystal capacitor Clca and the coupling capacitor Ccp according to a gate signal from the gate line 121, and the coupling capacitor Ccp may transfer the data voltage Vd to charge both the second liquid crystal capacitor Clcb and the coupling capacitor Ccp. A charged voltage Vb of the second liquid crystal capacitor Clcb may always be smaller than a charged voltage Va of the first liquid crystal capacitor Clca because of the coupling capacitor Ccp. Accordingly, by appropriately controlling the capacitance of the coupling capacitor Ccp, a ratio of the charging voltage Va of the first liquid crystal capacitor Clca and the charging voltage Vb of the second liquid crystal capacitor Clcb is controlled, thereby improving the lateral visibility.

In the liquid crystal display according to the several exemplary embodiments described above in connection with FIGS. 9 to 14, the first subpixel electrode and the second subpixel electrode constituting one terminal of each of the first liquid crystal capacitor Clca and the second liquid crystal capacitor Clcb included in the pixel PX may have the same shape and function as the lower electrode 191 described above in connection with the exemplary embodiments of FIGS. 1-8, and the common electrode 270 of each of the subpixels PXa and PXb may also have the same shape and function as the common electrode 270 described above in connection with the exemplary embodiments of FIGS. 1-8.

As such, in accordance with the liquid crystal display according to an exemplary embodiment of the present system and method, transmittance of the liquid crystal display may be improved by forming the plate-shaped portion 193 of the pixel electrodes of the basic regions of the field generating electrodes. Further, by forming the width of the vertical stem 71 of the cutout 271 of the common electrode 270 formed in the basic region of the field generating electrode to be increased from the end of the vertical stem 71 toward the central portion of the generating electrode, the azimuthal angle, which is a direction in which the director of the liquid crystal molecules positioned to be adjacent to the vertical stem 71 (i.e., the direction of the director of the liquid crystal molecules) can be additionally controlled, thereby preventing irregular movement of the liquid crystal molecules positioned to be adjacent to the vertical stem 71.

While the present system and method are described above in connection with exemplary embodiments, the present system and method are not limited to the disclosed embodiments. On the contrary, the present system and method cover various modifications and equivalent arrangements included within the spirit and scope of the appended claims.

<Description of Symbols>

| | |
|---|---|
| 100, 200: display panel | 110, 120: substrate |
| 121: gate line | 124a, 124b, 124c: gate electrode |
| 131: storage electrode line | 154a, 154b, 154c: semiconductor |

| | |
|---|---|
| 171, 171a, 171b: data line | 173a, 173b, 173c: source |
| | electrode |
| 175a, 175b, 175c: drain electrode | 180: passivation layer |
| 191a, 191b, 191: pixel electrode | 193: plate-shaped portion |

| | |
|---|---|
| 194: branch electrode | 220: light blocking member |
| 230: color filter | 270: common electrode |
| 271: cutout | 3: liquid crystal layer |

| | |
|---|---|
| 71: vertical stem | 72: horizontal stem |

What is claimed is:

1. A liquid crystal display comprising:
a first substrate;
a first electrode formed on the first substrate;
a second substrate configured to face the first substrate; and
a second electrode formed on the second substrate,
wherein the first electrode includes a first portion having a plate shape and a plurality of branch electrodes extended from the first portion,
the second electrode includes a cross-shaped cutout including a horizontal stem and a vertical stem that cross each other at a center thereof, and
the vertical stem of the cross-shaped cutout includes a first portion having a width that is increased from an end of the first portion of the vertical stem toward the center.

2. The liquid crystal display of claim 1, wherein the vertical stem of the cross-shaped cutout further includes a second portion having a constant width, and
the first portion of the vertical stem is positioned between the second portion and the center.

3. The liquid crystal display of claim 2, wherein a length of the first portion of the vertical stem is about 50% or more of a length of the vertical stem.

4. The liquid crystal display of claim 3, wherein the first portion of the first electrode has a rhombus shape, and
the branch electrodes are disposed to extend in four directions.

5. The liquid crystal display of claim 4, wherein the cross-shaped cutout of the second electrode includes an extension formed at the center, and
an edge of the extension is parallel with an edge of the first portion of the first electrode.

6. The liquid crystal display of claim 1, wherein the vertical stem has a width that is gradually increased from an end thereof toward the center.

7. The liquid crystal display of claim 6, wherein the first portion of the first electrode has a rhombus shape, and
the branch electrodes are disposed to extend in four directions.

8. The liquid crystal display of claim 7, wherein the cross-shaped cutout of the second electrode includes an extension formed at the center, and
an edge of the extension is parallel with an edge of the first portion of the first electrode.

9. The liquid crystal display of claim 1, wherein the first portion of the first electrode has a rhombus shape, and
the branch electrodes are disposed to extend in four directions.

10. The liquid crystal display of claim 9, wherein the cross-shaped cutout of the second electrode includes an extension formed at the center, and
an edge of the extension is parallel with an edge of the first portion of the first electrode.
